(19) United States
(12) Patent Application Publication
(10) Pub. No.: US 2019/0185711 A1
(43) Pub. Date: Jun. 20, 2019

(54) EPOXY RESIN COMPOSITION AND CURED RESIN FILM WITH LOW CURING SHRINKAGE AND EXCELLENT ADHESION

(71) Applicants: JNC CORPORATION, Tokyo (JP); JNC PETROCHEMICAL CORPORATION, Tokyo (JP)

(72) Inventors: Kazuya SUWA, CHIBA (JP); Masaru EGUCHI, CHIBA (JP); Hironori IKENO, CHIBA (JP); Tomoyuki OBA, CHIBA (JP)

(73) Assignees: JNC CORPORATION, Tokyo (JP); JNC PETROCHEMICAL CORPORATION, Tokyo (JP)

(21) Appl. No.: 16/328,688

(22) PCT Filed: Aug. 26, 2016
(86) PCT No.: PCT/JP2016/075056

§ 371 Date: Feb. 26, 2019

(51) Int. Cl. C09D 183/12; C08G 77/46; C08K 3/36; C09D 7/40

(52) U.S. Cl. CPC C09D 183/12; C08G 77/46; C08G 77/70; C09D 7/67; C08K 3/36

(57) ABSTRACT

An epoxy resin composition which is suppressed in curing shrinkage upon being cured to obtain a cured film having low warpage and high adhesion. The epoxy resin composition contains epoxy resin (A), compound (B) represented by formula (1) and nanosilica filler (C). In formula (1), R₁ and R₂ are independently an alkyl group having 1 to 10 carbons or a phenyl group, and X is independently hydrogen or a monovalent organic group, and in one molecule of the compound, at least one of X includes an epoxy group.

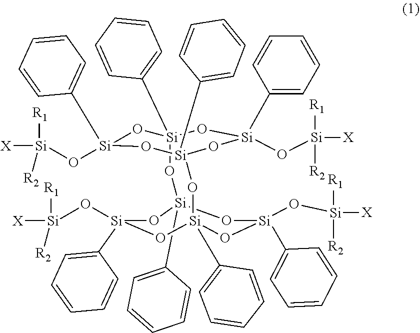

### TECHNICAL FIELD

The invention relates to an epoxy resin composition and a cured resin film with low curing shrinkage and excellent adhesion.

### BACKGROUND ART

An epoxy resin has been widely utilized for an adhesive, an electronic material, a paint, aerospace or the like owing to excellent adhesive properties, electrical characteristics, heat resistance and the like. High performance or improvement in an integration technology of electronic equipment have been recently remarkable, and a material has been required to have further higher performance or a higher function. Meanwhile, a silicon-oxygen compound typified by silica or silicone develops characteristics that are not exhibited in an organic material alone, and therefore attracts attention as an organic-inorganic hybrid material.

For example, a study has been made on an application of an organic-inorganic hybrid composed of an epoxy resin and an inorganic material as a technique for improving heat resistance of the epoxy resin. As the application of such an organic-inorganic hybrid, a report has been made on an organic-inorganic hybrid material using epoxy-modified silsesquioxane having both a siloxane bond being an inorganic component and an epoxy being an organic component within a molecule.

Patent literature No. 1 proposes a resin composition which provides a cured material which is excellent in phosphor dispersibility, and can provide a processed material which, when the cured material is processed and used as a color conversion material, has high heat resistance, resistance to heat-induced yellowing, light resistance, high transparency, and a high refractive index, and is excellent in adhesion onto a substrate, and is capable of stably converting color of light emitted from an optical semiconductor over a long period of time without unevenness of light.

Moreover, Patent literature No. 2 proposes a photosensitive resin composition containing a specific silicon compound (A) having an epoxy group and a photocationic polymerization initiator (B) for the purpose of providing a photosensitive resin composition and a hard coat film having the cured coating thereof, in which warpage of a film caused by curing shrinkage is less, the film is further excellent in scratch resistance, and has pencil hardness of higher than 3H on a polyester film.

### CITATION LIST

### Patent Literature

Patent literature No. 1: WO 2012/111765 A1.

Patent literature No. 2: JP 2005-15581 A.

### SUMMARY OF INVENTION

### Technical Problem

Upon curing an epoxy resin by heat or ultraviolet light, shrinkage by curing is caused, although a level is much smaller than the shrinkage of an acrylic resin, and causes a problem such as deterioration of a surface shape, peeling from a base material caused by stress and curling of the base material in several cases. According to a study by the present inventors, a cured film of a photosensitive resin composition described in Patent literature No. 2 has been found to be able to achieve pencil hardness of 3H on polyethylene terephthalate (PET), but unable to obtain sufficient low warpage. A demand for suppressing curing shrinkage has been recently increased in association with achievement of fineness of electronic equipment. In addition, a demand has been expressed on various performance such as adhesion and transparency according to an application.

Accordingly, amain object of the invention is to provide an epoxy resin composition which is suppressed in curing shrinkage upon being cured to obtain a cured film having low warpage and high adhesion. Moreover, a further object of the invention is to provide an epoxy resin composition in which the cured film has low warpage, and satisfies both high hardness and high adhesion. Moreover, a further object is to provide a laminate having low warpage and high adhesion.

### Solution to Problem

The present inventors have diligently continued to conduct a study. As a result, the present inventors have found that curing shrinkage upon being cured can be suppressed and a cured film having low warpage and high adhesion can be obtained by combining an epoxy resin and a compound represented by formula (1). Further, the present inventors have found that high hardness of H or more in pencil hardness can be achieved.

An embodiment of the invention includes structure described below.

[1] An epoxy resin composition, containing epoxy resin (A), compound (B) represented by formula (1) and nanosilica filler (C):

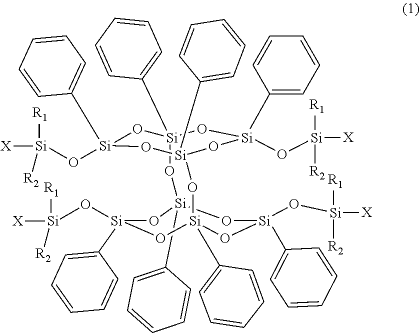

wherein, in formula (1), R₁ and R₂ are independently an alkyl group having 1 to 10 carbons or a phenyl group, and X is independently hydrogen or a monovalent organic group, and in one molecule of the compound, at least one of X includes an epoxy group.

[2] The epoxy resin composition according to [1] , wherein, in the formula (1), all of R₁ and R₂ are a methyl group or an ethyl group.

[3] The epoxy resin composition according to [1] or [2] , wherein, in the formula (1), all of X include an epoxy group.

[4] The epoxy resin composition according to any one of [1] to [3], wherein the epoxy resin (A) contains a phosphorus-containing epoxy resin.

[5] The epoxy resin composition according to any one of [1] to [4], wherein the compound (B) represented by formula (1) contains at least one kind of a compound selected from the group of a compound represented by formula (2), a compound represented by formula (3) and a compound represented by formula (4):

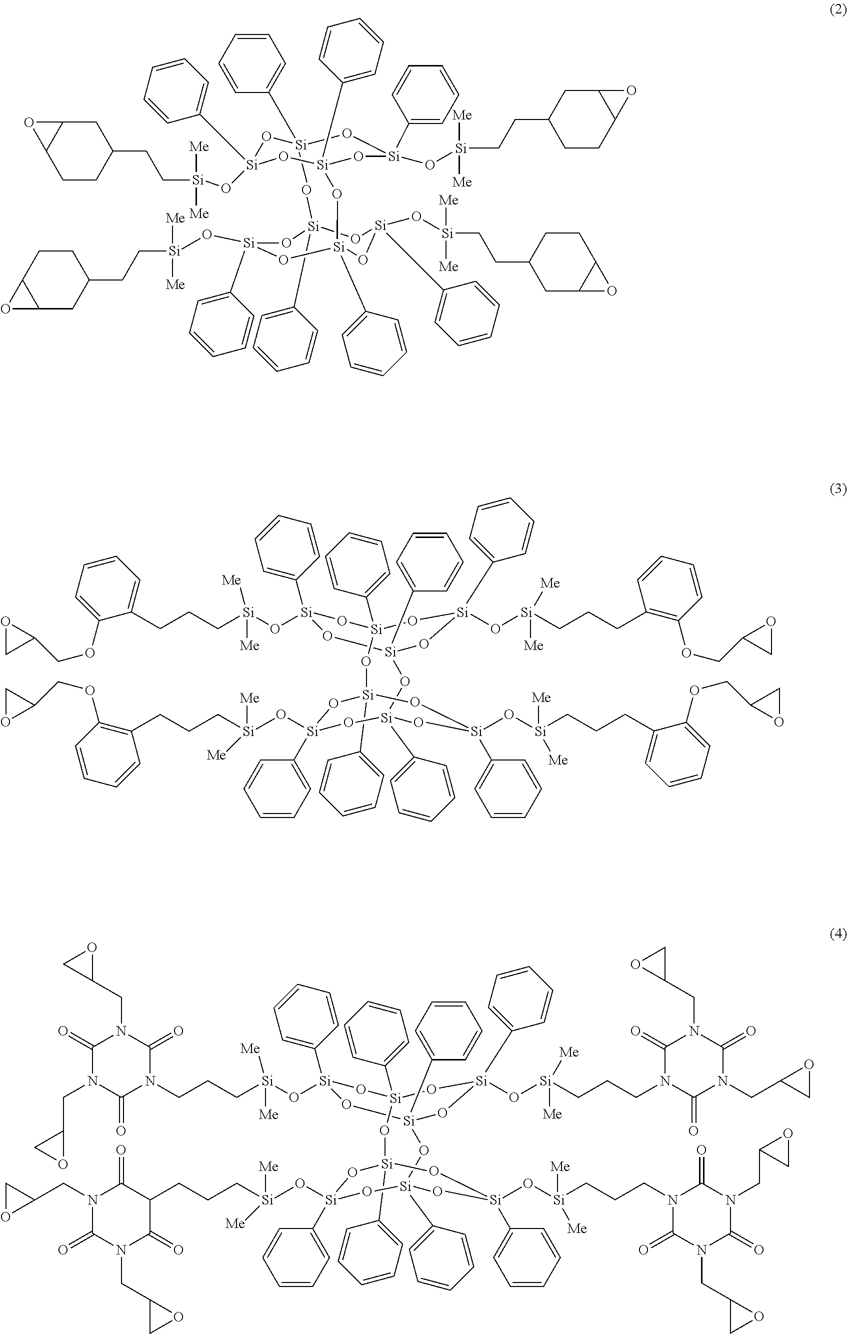

[6] The epoxy resin composition according to any one of [1] to [5], wherein the epoxy resin (A) is a polyfunctional monomer type epoxy resin.

[7] The epoxy resin composition according to any one of [1] to [6], wherein the epoxy resin composition contains 10% by mass or more and 80% by mass or less of epoxy resin (A), 5% by mass or more and 80% by mass or less of the compound (B) represented by formula (1) and 5% by mass or more and 35% by mass or less of the nanosilica filler (C).

[8] The epoxy resin composition according to any one of [1] to [7], wherein amass ratio of a content of the epoxy resin (A) to a content of the compound (B) represented by formula (1) is 1:0.2 to 1:5.

[9] The epoxy resin composition according to any one of [1] to [8], further containing resin (D) other than the epoxy resin.

[10] A laminate, including a base material and a cured film formed by curing an epoxy resin composition containing at least epoxy resin (A) and compound (B) represented by formula (1) on the base material, wherein a mass ratio of a content of component (A) to a content of component (B) in the epoxy resin composition is 1.0:0.3 to 1.0:4.0, and adhesion on all of three kinds of base materials is rated to be 4B or more on the epoxy resin composition containing at least the epoxy resin (A) and the compound (B) represented by formula (1) in adhesion evaluation by evaluation method 1:

### Evaluation Method 1

a cured film having a thickness of 4 to 5 micrometers and composed of an epoxy resin composition containing at least the epoxy resin (A) and the compound (B) represented by formula (1) is formed on three kinds of base materials of metal oxide, a metal substrate and a plastic film each having a thickness of 50 micrometers, respectively; and

an adhesion test is performed on a formed cured film by using a crosscut adhesion method with 25 (5×5) lattice patterns at a spacing of 1 millimeter in accordance with ASTM D3359 (Method B) and adhesion is evaluated on the following criteria:

### Evaluation Criteria

5B: 0% in percent area removed;

4B: less than 5% in percent area removed;

3B: 5% or more and less than 15% in percent area removed;

2B: 15% or more and less than 35% in percent area removed;

1B: 35% or more and less than 65% in percent area removed; and

0B: 65% or more in percent area removed;

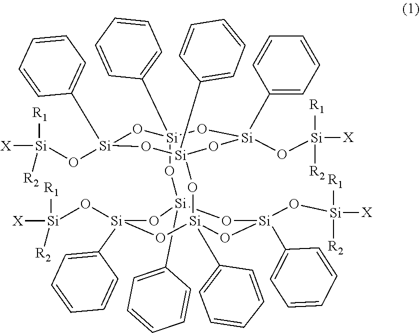

wherein, in formula (1), R₁ and R₂ are independently an alkyl group having 1 to 10 carbons or a phenyl group, and X is independently hydrogen or a monovalent organic group, and in one molecule of the compound, at least one of X includes an epoxy group.

[11] The laminate according to [10], wherein, in the formula (1), all of R₁ and R₂ are a methyl group or an ethyl group.

[12] The laminate according to [10] or [11], wherein, in the formula (1), all of X include an epoxy group.

[13] The laminate according to any one of [10] to [12], wherein the epoxy resin (A) contains a phosphorus-containing epoxy resin.

[14] The laminate according to any one of [10] to [13], wherein the base material is one kind selected from the group of metal oxide, a plastic film and a metal substrate.

An electronic component, including the laminate according to any one of [10] to [14].

### Advantageous Effects of Invention

The invention provides an epoxy resin composition which is suppressed in curing shrinkage upon being cured to obtain a cured film having low warpage and high adhesion.

### Description of Embodiments

### 1. Epoxy Resin Composition

A first embodiment of the invention relates to an epoxy resin composition containing epoxy resin (A), compound (B) represented by formula (1) and nanosilica filler (C). Epoxy resin (A) is represented as component (A), compound (B) represented by formula (1) is represented as component (B) and nanosilica filler (C) is represented as component (C) in several cases. Any other component of the resin composition may be occasionally simplified and referred to in a similar manner.

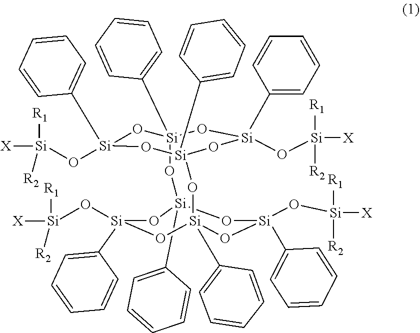

In formula (1), R₁ and R₂ are independently an alkyl group having 1 to 10 carbons or a phenyl group, and X is independently hydrogen or a monovalent organic group, and in one molecule of the compound, at least one of X includes an epoxy group.

### Epoxy Resin (A)

The epoxy resin is not particularly limited as long as compatibility with any other component composing the resin composition is satisfactory, in which the epoxy resin including 1 to 8 epoxy groups per one molecule and having a weight average molecular weight of less than 5,000 is preferred. The number of epoxies included in the epoxy resin per one molecule is preferably 2 to 4. If the number of epoxies is within the above range, a curing rate and heat resistance are improved.

The weight average molecular weight of the epoxy resin is preferably 80 to 10,000, further preferably 100 to 5,000, and still further preferably 120 to 600. If the weight average molecular weight is within the above range, leveling of an ink coat is improved.

An epoxy equivalent of epoxy resin (A) is preferably 80 g/eq or more and 1,000 g/eq or less, further preferably 100 g/eq or more and 500 g/eq or less, and still further preferably 120 g/eq or more and 300 g/eq or less. Curability of the epoxy resin composition is further improved, and the heat resistance of a cured material is improved by adjusting the equivalent in the above range.

From viewpoints of excellent storage stability, elastic modulus and Tg of the cured material, preferred examples of the epoxy resin include a phenol novolak type epoxy resin, a cresol novolak type epoxy resin, a glycidyl ether type epoxy resin, a bisphenol A novolak type epoxy resin, a hydrogenated bisphenol A type epoxy resin, aliphatic polyglycidyl ether, a cyclic aliphatic epoxy resin and a polyfunctional monomer type epoxy resin. Above all, particularly preferred examples include a glycidyl ether type epoxy resin, a bisphenol A novolak type epoxy resin, a phenol novolak type epoxy resin, a cresol novolak type epoxy resin and a polyfunctional monomer type epoxy resin, which have excellent heat resistance. In addition, a phosphorus-containing epoxy resin that contains phosphorus may be used.

Epoxy resins (A) maybe used alone in one kind of the above-described materials or in combination with two or more kinds thereof.

Specific examples of the epoxy resin include 3′,4′-epoxycyclohexylmethyl 3,4-epoxycyclohexanecarboxylate, 3,4,3′,4′-diepoxybicyclohexyl, 1,2-epoxy-4-vinylcyclohexane, s-caprolactone-modified 3′,4′-epoxycyclohexylmethyl 3,4-epoxycyclohexanecarboxylate, 2,2-bi(4-glycidyloxyphenyl) propane, a mixture of 2-[4-(2,3-epoxypropoxy) phenyl]-2-[4-[1,1-bis [4-([2,3-epoxypropoxy]phenyl) ethyl]phenyl]propane and 1,3-bis [4-[1-[4-(2,3-epoxypropoxy) phenyl]-1-[4-[1-[4-(2,3-epoxypro poxyphenyl)-1-methylethyl]phenyl]ethyl]phenoxy]-2-propanol, and 2-[4-(2,3-epoxypropoxy) phenyl]-2-[4-[1, 1-bis[4-([2,3-epoxypropoxy]phenyl)]ethyl]phenyl]propane. Particularly preferred examples include 3′,4′-epoxycyclohexylmethyl 3,4-epoxycyclohexanecarboxylate and 3,4,3′,4′-diepoxybicyclohexyl.

Moreover, as the epoxy resin, a commercial item as described below can be used. Specific examples of a glycidyl ether type epoxy resin including 3 to 20 epoxies per one molecule and having a weight average molecular weight of less than 5,000 include TECHMORE VG3101L (Printec Corporation), EPPN-501H and EPPN-502H (Nippon Kayaku Co., Ltd.) and JER 1032H60 (Mitsubishi Chemical Corporation). Specific examples of the bisphenol A novolak type epoxy resin include JER 157S65 and JER 157S70 (Mitsubishi Chemical Corporation). Specific examples of the phenol novolak type epoxy resin include EPPN-201 (Nippon Kayaku Co., Ltd.), and JER 152 and JER 154 (Mitsubishi Chemical Corporation). Specific examples of the cresol novolak type epoxy resin include EOCN-102S, EOCN-103S, EOCN-104S and EOCN-1020 (Nippon Kayaku Co., Ltd.). Specific examples of the polyfunctional monomer type epoxy resin include Celloxide (registered trademark) CEL2021P, CEL2000 and CEL8000 (Daicel Corporation). Specific examples of the phosphorus-containing epoxy resin include ADEKA RESIN (registered trademark) EP-49-1OP and EP-49-10P2 (ADEKA Corporation).

A proportion of the epoxy resin is 10 to 80% by mass based on the total amount of a solid content in the resin composition. If the proportion of the epoxy resin is within the above range, a balance among low warpage, heat resistance, chemical resistance and adhesion is satisfactory. A further preferred proportion of the epoxy resin is in the range of 20 to 60% by mass. Moreover, an effect of improving adhesion onto a metal or metal oxide layer by chelating can be expected by containing the phosphorus-containing epoxy resin that contains phosphorus, preferably, in the range of 2% by mass to 25% by mass in the epoxy resin composition.

### Compound (B) Represented by Formula (1)

A compound represented by formula (1) is double-decker type phenyl silsesquioxane including at least one epoxy group in one molecule. In addition, the compound represented by formula (1) is occasionally described as compound (1). A compound represented by any other formula is occasionally simplified and referred to in a similar manner.

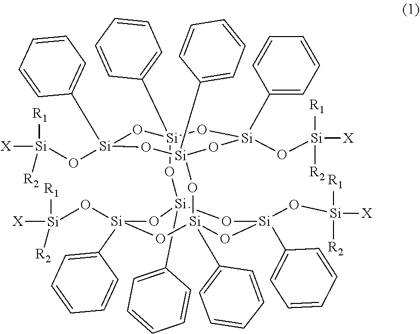

In formula (1), R₁ and R₂ are independently an alkyl group having 1 to 10 carbons or a phenyl group, and X is independently hydrogen or a monovalent organic group, and in one molecule of the compound, at least one of X includes an epoxy group.

R₁ and R₂ are independently preferably an alkyl group having 1 to 6 carbons or a phenyl group, and further preferably a methyl group or an ethyl group.

R₁ and R₂ may be identical to or different from each other. The alkyl group means a functional group formed by eliminating one hydrogen from a terminal of alkane, which is represented by CₙH₂ₙ₊₁. R₁ and R₂ may be any of a straight-chain alkyl group and a branched-chain alkyl group. In addition, in a case of the branched chain, a carbon on the branched chain is to be included in the number of carbons. Specific examples of the alkyl group having 1 to 10 carbons include methyl, ethyl, propyl, 1-methylethyl, butyl, 2-methylpropyl, 1,1-dimethylethyl, pentyl, hexyl, 1,1,2-trimethylpropyl, heptyl and octyl.

All of R₁ and R₂ are particularly preferably a methyl group or an ethyl group, and all of R₁ and R₂ are most preferably a methyl group from viewpoints of reactivity and heat resistance.

X may be identical to or different from each other. In one molecule of the compound, at least one of X includes an epoxy group, two of X preferably includes an epoxy group, and three of X further preferably includes an epoxy group, and all of four of X most preferably include an epoxy group from viewpoints of reactivity, compatibility with a resin, heat resistance and stability of a cured film.

Specific examples of the monovalent organic group include an alkoxy group, an aryloxy group, an amino group, an amide group, an alkoxycarbonyl group, an aryloxycarbonyl group, an alkylcarbonyl group, an arylcarbonyl group, an alkylthio group, an arylthio group, an epoxy group, a vinyl ether group, an aliphatic hydrocarbon group that may have a substituent, an aromatic hydrocarbon group that may have a substituent, an aliphatic heterocyclic group that may have a substituent and an aromatic heterocyclic group that may have a substituent. Specific examples of the substituent include an alkoxy group, an aryloxy group, an amino group, an amide group, an alkoxycarbonyl group, an aryloxycarbonyl group, an alkylcarbonyl group, an arylcarbonyl group, an alkylthio group, an arylthio group, an epoxy group, a vinyl ether group and halogen. Moreover, the number of the substituents is not particularly limited, and the monovalent organic group may have a plurality of substituents as long as the number is within a replaceable range. Moreover, the monovalent organic group may have two or more kinds of substituents. Moreover, arbitrary non-adjacent —CH₂— may be replaced by —O—, —CH═CH— or the like.

Specific examples of the compound represented by formula (1) include compounds described below. Above all, from a viewpoint of cure with curing shrinkage suppression, a compound represented by formula (2), a compound represented by formula (3) or a compound represented by formula (4) is preferred.

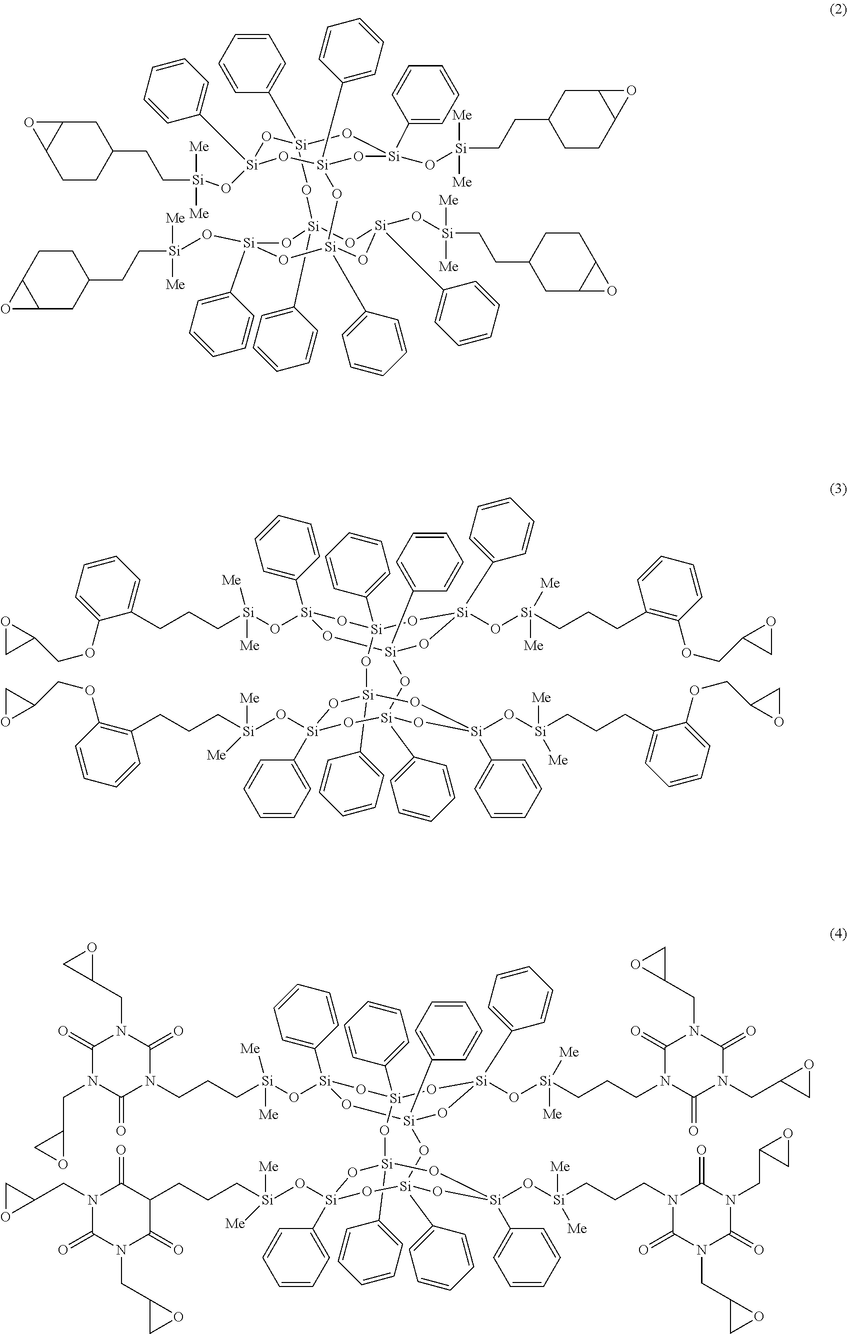

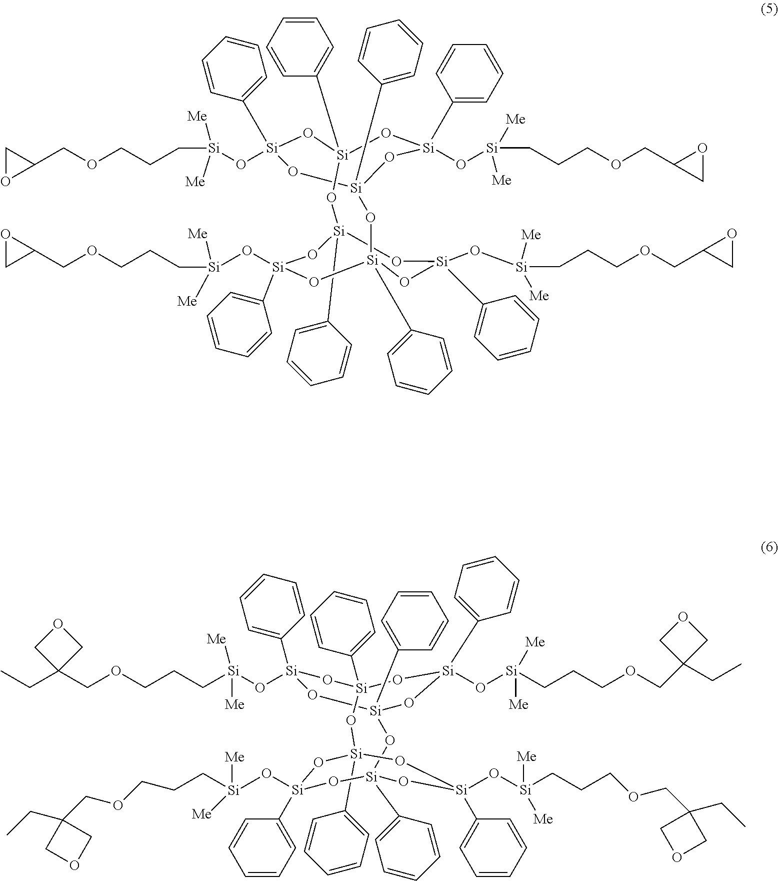 [SMILES: C[Si](C)(CCCOCC1CO1)O[Si]1(c2ccccc2)O[Si]2(c3ccccc3)O[Si](O[Si](C)(C)CCCOCC3CO3)(c3ccccc3)O[Si](c3ccccc3)(O1)O[Si]1(c3ccccc3)O[Si](O[Si](C)(C)CCCOCC3CO3)(c3ccccc3)O[Si](c3ccccc3)(O[Si](O[Si](C)(C)CCCOCC3CO3)(c3ccccc3)O1)O2 ; CCC1(COCCC[Si](C)(C)O[Si]2(c3ccccc3)O[Si]3(c4ccccc4)O[Si](O[Si](C)(C)CCCOCC4(CC)COC4)(c4ccccc4)O[Si](c4ccccc4)(O2)O[Si]2(c4ccccc4)O[Si](O[Si](C)(C)CCCOCC4(CC)COC4)(c4ccccc4)O[Si](c4ccccc4)(O[Si](O[Si](C)(C)CCCOCC4(CC)COC4)(c4ccccc4)O2)O3)COC1]

Compound (B) represented by formula (1) can be synthesized according to the method described in WO 2004/024741 A, for example. The compound represented by formula (2) can be produced by the method described in Synthesis Example 1 in WO 2012/111765 A, for example.

A content of compound (B) represented by formula (1) in the epoxy resin composition which is one embodiment according to the invention is preferably 5 to 80% by mass, and further preferably 20 to 40% by mass, based on the total amount for the total amount of solid content in the epoxy resin composition (a remaining component upon excluding a solvent from the epoxy resin composition). The cured material exhibits excellent characteristics on heat resistance, transparency, yellowing resistance, resistance to heat-induced yellowing, light resistance, surface hardness, adhesion and photocationic curability by adjusting the content to the above range.

From viewpoints of curing shrinkage suppression and high adhesion, a mass ratio of a content of component (A) to a content of component (B) in the epoxy resin composition is preferably 1:0.2 to 1:5, further preferably 1:0.3 to 1:4, and still further preferably 1:0.6 to 1:0.95.

Moreover, from viewpoints of curing shrinkage suppression and high adhesion, a combination of component (A) and component (B) in the epoxy resin particularly includes a combination of 3′,4′-epoxycyclohexylmethyl 3,4-epoxycyclohexanecarboxylate and a compound represented by formula (2), a combination of 3′,4′-epoxycyclohexylmethyl 3,4-epoxycyclohexanecarboxylate and a compound represented by formula (3), a combination of 3′,4′-epoxycyclohexylmethyl 3,4-epoxycyclohexanecarboxylate and a compound represented by formula (4), and a combination in which a phosphorus-containing epoxy resin is added to each of the combinations.

### Nanosilica Filler (C)

A resin composition, which is one embodiment according to the invention, preferably contains a nanosilica filler.

In general, thermal conductivity and electrical insulation properties can be provided by adding the nanosilica filler. The present inventors have surprisingly found that not only an effect of improving the thermal conductivity and the electrical insulation properties, but also adhesion onto a metal oxide film, metal such as Al and Cu, PET or the like is improved on the cured material of the resin composition by combining the epoxy resin, the compound represented by formula (1) and the nanosilica filler. Further, the present inventors have found that the cured film having hard coat performance having H or more in pencil hardness and low warpage can be achieved by combining the epoxy resin, the compound represented by formula (1) and the nanosilica filler.

A mean particle diameter of the nanosilica filler is not limited as long as the diameter thereof is in a nanometer order, and is preferably 1 to 100 nanometers, and from a viewpoint of transparency, further preferably 1 to 40 nanometers, and still further preferably 1 to 20 nanometers. Moreover, a particle size distribution is preferably narrower.

A shape of the nanosilica filler is not particularly limited, and may be any shape such as a spherical shape, an infinite shape and scaly shape, and from viewpoints of adhesion improvement and transparency, a spherical shape is preferred. In addition, when the shape of the nanosilica filler is other than the spherical shape, the mean particle diameter of the nanosilica filler means a mean maximum diameter of the filler.

Moreover, the nanosilica filler may be subjected to surface treatment with a silane coupling agent or the like.

In the resin composition, a content of the nanosilica filler as component (C) is preferably 5% by mass or more and 35% by mass or less, and further preferably 10% by mass or more and 20% by mass or less, in terms of % by mass based on the total amount of the solid content total amount of the epoxy resin composition.

In the present embodiment, the resin composition may be used by adding the nanosilica filler to the epoxy resin, or a commercial item in which the nanosilica filler is dispersed in the resin may be used.

Specific examples of such a commercial item include a nanosilica-dispersed epoxy resin {Nanopox (registered trademark) series (C620, F400, E500, E600, E430)} in which 40% by mass of nanosilica is dispersed in an epoxy resin, and Nanocryl (registered trademark) series (C130, C140, C145, C146, C150, C153, C155, C165, C350) in which 50% by mass of nanosilica is dispersed in an acrylate resin, both made by Evonik industries AG.

From viewpoints of curing shrinkage suppression and high adhesion, the epoxy resin composition preferably contains 10% by mass or more and 80% by mass or less of component (A), 5% by mass or more and 80% by mass or less of component (B) and 5% by mass or more and 35% by mass or less of component (C), and further preferably contains 20% by mass or more and 60% by mass or less of component (A), 20% by mass or more and 40% by mass or less of component (B) and 10% by mass or more and 20% by mass or less of component (C), in terms of % by mass based on the total mass of all components of the epoxy resin composition. Further, the epoxy resin composition preferably contains 10% by mass or more and 80% by mass or less of component (A), 5% by mass or more and 80% by mass or less of component (B) and 5% by mass or more and 35% by mass or less of component (C), and further preferably contains 20% by mass or more and 60% by mass or less of component (A), 20% by mass or more and 40% by mass or less of component (B) and 10% by mass or more and 20% by mass or less of component (C), in terms of % by mass based on the total mass of the solid content in the epoxy resin composition.

In addition, when a commercial item in which the nanosilica filler is dispersed in the resin is used, an amount of component (C) is the amount of the nanosilica filler therein.

Moreover, various components such as any other resin, a surfactant and an antioxidant can be added to the epoxy resin composition, when necessary.

### (D) Any Other Resin

The resin composition, which is one embodiment according to the invention, may contain a resin (any other resin) other than the epoxy resin in the range in which advantageous effects of the invention are not adversely affected. As the resin other than the epoxy resin, a resin including a crosslinkable functional group is preferred.

For example, from viewpoints of high-speed curing of the epoxy resin, curing shrinkage suppression or the like, an oxetane resin, a resin having a vinyl ether group, such as cyclohexanedimethanol divinyl ether can be used.

Specific examples of the commercial item include an oxetane resin {Aron Oxetane (trade name) OXT-221}, {Aron Oxetane (trade name) OXT-101}, {Aron Oxetane (trade name) OXT-212} and {Aron Oxetane (trade name) OXT-121}, made by Toagosei Co., Ltd., vinyl ether {1,4-cyclohexanedimethanol divinyl ether} made by Sigma-Aldrich K.K., and {cyclohexanedimethanol divinyl ether (abbreviation) CHDVE}, {triethyleneglycol divinyl ether (abbreviation) TEGDVE}, {1,4-butanediol divinyl ether (abbreviation) BDVE} and {diethyleneglycol divinyl ether (abbreviation) DEGDVE}, made by Nippon Carbide Industries Co., Inc.

### Solvent (E)

The resin composition, which is one embodiment according to the invention, may contain a solvent. Examples of the solvent include a hydrocarbon-based solvent (hexane, benzene or toluene), an ether-based solvent (diethyl ether, tetrahydrofuran (THF), 2-methyltetrahydrofuran, diphenyl ether, anisole, dimethoxybenzene, or cyclopentyl methyl ether (CPME)), a halogenated hydrocarbon-based solvent (methylene chloride, chloroform, or chlorobenzene), a ketone-based solvent (acetone, methyl ethyl ketone, or methyl isobutyl ketone), an alcohol-based solvent (methanol, ethanol, propanol, isopropanol, n-butyl alcohol, or t-butyl alcohol), a nitrile-based solvent (acetonitrile, propionitrile, or benzonitrile), an ester-based solvent (ethyl acetate, or butyl acetate), a carbonate-based solvent (ethylene carbonate, or propylene carbonate), an amide-based solvent (N,N-dimethylformamide, N,N-dimethylacetamide or N-methylpyrrolidone), a hydrochlorofluorocarbon-based solvent (HCFC-141b or HCFC-225), a hydrofluorocarbon (HFCs)-based solvent (HFCs having 2 to 4, 5, and 6 or more carbons), a perfluorocarbon-based solvent (perfluoropentane or perfluorohexane), an alicyclic hydrofluorocarbon-based solvent (fluorocyclopentane or fluorocyclobutane), an oxygen-containing fluorine-based solvent (fluoroether, fluoropolyether, fluoroketone or fluoroalcohol), an aromatic-based fluorine solvent (α,α,α-trifluorotoluene or hexafluorobenzene) and water. The above materials may be used alone or in combination with two or more kinds.

For example, from a viewpoint of application properties, an amount of the solvent to be used is at a level at which a content of epoxy resin (A) and compound (B) represented by formula (1) preferably becomes 20 to 80% by mass, and further preferably becomes 30 to 70% by mass, and still further preferably becomes 40 to 60% by mass, based on the total amount of the epoxy resin composition.

### Curing Agent (F)

Examples of the curing agent include an acid anhydride-based curing agent, an amine-based curing agent and a phenol-based curing agent. In view of productivity, a cationic polymerization initiator is preferred.

### Cationic Polymerization Initiator

Examples of the cationic polymerization initiator include an active energy ray polymerization initiator that generates cationic species or Lewis acid by an active energy ray such as ultraviolet light, and a thermal polymerization initiator that generates cationic species or Lewis acid by heat. An active energy ray cationic polymerization initiator includes an initiator that generates cationic species by heat, such as part of aromatic onium salt, and such a salt can also be used as a thermal cationic polymerization initiator.

Examples of the active energy ray cationic polymerization initiator include an arylsulfonium complex salt, an aromatic sulfonium or iodonium salt of a halogen-containing complex ion, and an aromatic onium salt of group II, V and VI elements. Several of the above salts can be obtained as a commercial product. Specific examples of the active energy ray cationic polymerization initiator include {CPI-110p (registered trademark)}, {CPI-210K (registered trademark)}, {CPI-210S (registered trademark)}, {CPI-300PG (registered trademark)} and {CPI-410S (registered trademark)}, made by San-Apro Ltd., {Adekaoptomer (registered trademark) SP-130}, {Adekaoptomer (registered trademark) SP-140}, {Adekaoptomer (registered trademark) SP-150}, {Adekaoptomer (registered trademark) SP-170} and {Adekaoptomer (registered trademark) SP-171}, made by ADEKA Corporation, and {IRGACURE(registered trademark) 250}, {IRGACURE(registered trademark) 270} and {IRGACURE(registered trademark) 290}, made by BASF Japan Ltd.

As the thermal cationic polymerization initiator, a cationic or protonic acid catalyst such as a salt of triflic acid and boron trifluoride is used. Examples of a preferred thermal cationic polymerization initiator is a salt of triflic acid, and specific examples thereof include diethylammonium triflate, diisopropylammonium triflate and ethyldiisopropylammonium triflate. On the other hand, aromatic onium salts used also as the active energy ray cationic polymerization initiator include several salts that generate cationic species by heat, and the salts can also be used as the thermal cationic polymerization initiator.

The thermal cationic polymerization initiator can be blended uniformly in the resin composition, and the resin composition can be cured in a catalyst type, and therefore can be cured at low temperature and in a short period of time and has good solvent stability, and such a case is preferred. Moreover, among the above cationic polymerization initiators, an aromatic onium salt is preferred in view of excellence in a balance among handling and a potential and curability, and above all, a diazonium salt, an iodonium salt, a sulfonium salt and a phosphonium salt are preferred in view of excellence in a balance between handling and a potential. The cationic polymerization initiators can be used alone or in combination with two or more kinds thereof.

Specific examples of a commercial item of the thermal cationic polymerization agent include trade names “Adekaopton CP-66” and “CP-77”, made by ADEKA Corporation: trade names “SAN-AID SI-45L”, “SI-60L”, “SI-80L”, “SI-100L”, “SI-110L”, “SI-180L”, “SI-B2A”, “SI-B3” and “SI-B3A”, made by SANSHIN CHEMICAL INDUSTRY CO.,LTD. and trade name “FC-520,” made by 3M Japan Limited. The heat cationic polymerization initiators may be used alone in one kind or in combination with two or more kinds thereof.

### Acid Anhydride

Specific examples of the acid anhydride include phthalic anhydride, maleic anhydride, trimellitic anhydride, pyromellitic anhydride, hexahydrophthalic anhydride, 3-methyl-cyclohexanedicarboxylic anhydride, 4-methyl-cyclohexanedicarboxylic anhydride, a mixture of 3-methyl-cyclohexanedicarboxylic anhydride and 4-methyl-cyclohexanedicarboxylic anhydride, tetrahydrophthalic anhydride, nadic anhydride, methylnadic anhydride, norbornane-2,3-dicarboxylic anhydride, methylnorbornane-2,3-dicarboxylic anhydride, cyclohexane-1,3,4-tricarboxylic acid-3,4-anhydride and a derivative thereof. Above all, 4-methyl-cyclohexanedicarboxylic anhydride and a mixture of 3-methyl-cyclohexanedicarboxylic anhydride and 4-methyl-cyclohexanedicarboxylic anhydride are liquid at room temperature, and therefore can be easily handled, and are preferred.

### Amine

Specific examples of an amine to be used as the curing agent include ethylenediamine, diethylenetriamine, triethylenetetramine, tetraethylenepentamine, dimethylaminopropylamine, diethylaminopropylamine, hexamethylenetriamine, biscyanoethylamine, tetramethylguanidine, pyridine, piperidine, methanediamine, isophoronediamine, 1,3-bis-aminomethyl-cyclohexane, bis(4-amino-cyclohexyl)methane, bis(4-amino-3-methyl-cyclohexyl)methane, benzylmethylamine, α-methyl-benzylmethylamine, m-phenylenediamine, m-xylylenediamine, diaminodiphenylmethane, diaminodiphenyl sulfone and diaminodiphenyl ether.

When acid anhydride or amine is used as the curing agent, a preferred use ratio is 0.7 to 1.2 equivalents of acid anhydride or amine, and further preferably 0.9 to 1.1 equivalents thereof relative to 1 equivalent of the epoxy contained in epoxy resin (A) and compound (B) represented by formula (1). When a blending amount of the curing agent is within the range described above, a curing reaction rapidly progresses and no coloring is caused in the cured material obtained, and such a case is preferred.

### Surfactant (G)

The surfactant can also be used for improving wettability, leveling or application properties for the base material, and is ordinarily used by addition in an amount of 0.01 to 1% by mass, and preferably 0.1 to 0.3% by mass, based on 100% by mass of the epoxy resin composition. The surfactant may be used in one kind of the compound or in combination with two or more kinds of the compounds.

Specific examples of the surfactant include Polyflow No. 45, Polyflow KL-245, Polyflow No. 75, Polyflow No. 90 and Polyflow No. 95 (Kyoeisha Chemical Co., Ltd.), Disperbyk-161, Disperbyk-162, Disperbyk-163, Disperbyk-164, Disperbyk-166, Disperbyk-170, Disperbyk-180, Disperbyk-181, Disperbyk-182, BYK-300, BYK-306, BYK-310, BYK-320, BYK-330, BYK-342, BYK-346, BYK-UV3500 and BYK-UV3570 (BYK-Chemie Japan K. K.), KP-341, KP-358, KP-368, KF-96-50CS and KF-50-100CS (Shin-Etsu Chemical Co., Ltd.), Surflon SC-101 and Surflon KH-40 (AGC Seimi Chemical Co., Ltd.), Ftergent 222F, Ftergent 251 and FTX-218 (Neos Company Limited), EFTOP EF-351, EFTOP EF-352, EFTOP EF-601, EFTOP EF-801 and EFTOP EF-802 (Mitsubishi Materials Corp.), MEGAFACE (registered trademark) F-410, MEGAFACE (registered trademark) F-430, MEGAFACE (registered trademark) F-444, MEGAFACE (registered trademark) F-472SF, MEGAFACE (registered trademark) F-475, MEGAFACE (registered trademark) F-477, MEGAFACE (registered trademark) F-552, MEGAFACE (registered trademark) F-553, MEGAFACE F-554, MEGAFACE F-555, MEGAFACE (registered trademark) F-556, MEGAFACE (registered trademark) F-558, MEGAFACE (registered trademark) F-563, MEGAFACE (registered trademark) R-94, MEGAFACE (registered trademark) RS-75 and MEGAFACE (registered trademark) RS-72-K (DIC Corporation), TEGO Rad 2200N and TEGO Rad 2250N (Evonik Japan Co., Ltd.) and Silaplane (registered trademark) FM-0511 (JNC corporation).

### Antioxidant (H)

The epoxy resin composition according to one embodiment according to the invention may contain the antioxidant. Improvement of heat resistance and weather resistance can be expected by containing the antioxidant. Moreover, oxidative degradation during heating can be prevented and coloring can be suppressed by containing the antioxidant. A blending proportion of the antioxidant in the epoxy resin composition is preferably 0.1% by mass to 2.0% by mass based on the total amount of the epoxy resin composition.

Examples of the antioxidant include a phenol-based antioxidant and a phosphorus-based antioxidant, and specific examples include monophenols, bisphenols, polymer-type phenols, phosphites and oxaphosphaphenanthrene oxides.

Specific examples of the monophenols include 2,6-di-t-butyl-p-cresol, butylated hydroxyanisole, 2,6-di-t-butyl-p-ethylphenol and stearyl-β-(3,5-di-t-butyl-4-hydroxyphenyl)propionate.

Specific example of the bisphenols include 2,2′-methylenebis(4-methyl-6-t-butylphenol), 2,2′-methylenebis(4-ethyl-6-t-butylphenol), 4,4′-thiobis(3-methyl-6-t-butylphenol), 4,4′-butylidenebis(3-methyl-6-t-butylphenol) and 3,9-bis[1,1-dimethyl-2-β-(3-t-butyl-4-hydroxy-5-methylphenyl)prop ionyloxy]ethyl]2,4,8,10-tetraoxaspiro[5,5]undecane.

Specific examples of the polymer-type phenols include 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionat e]methane, bis[3,3′-bis-(4′-hydroxy-3′-t-butylphenyl)butyric acid]glycol ester, 1,3,5-tris(3′,5′-di-t-butyl-4′-hydroxybenzyl)-S-triazine-2,4,6-(1H,3H,5H)trione, and tocophenol.

Specific examples of the phosphites include triphenyl phosphite, diphenyl isodecyl phosphite, phenyl di-isodecyl phosphite, tris(nonylphenyl) phosphite, diisodecylpentaerythritol phosphite, tris(2,4-di-t-butylphenyl)phosphite, cyclic neopentane tetraylbis(octadecyl)phosphite, cyclic neopentane tetraylbi(2,4-di-t-butylphenyl)phosphite, cyclic neopentane tetraylbi(2,4-di-t-butyl-4-methylphenyl)phosphite and bis[2-t-butyl-6-methyl-4-{2-(octadecyloxycarbonyl)ethyl}phenyl]hyd rogen phosphite.

Specific examples of the oxaphosphaphenanthrene oxides include 9,10-dihydro-9-oxa-10-phosphaphenanthrene-10-oxide, 10-(3,5-di-t-butyl-4-hydroxybenzyl)-9,10-dihydro-9-oxa-10-phosphap henanthrene-10-oxide and 10-decyloxy-9,10-dihydro-9-oxa-10-phosphaphenanthrene-10-oxide.

Specific examples of a commercially available antioxidant include Irgafos 168, Irgafos XP40, Irgafos XP60, Irganox 1010, Irganox 1035, Irganox 1076, Irganox 1135, Irganox 1520L (BASF Japan Ltd.) and ADK STAB (registered trademark) AO-20, AO-30, AO-40, AO-50, AO-60, AO-75, AO-80 and AO-330 (ADEKA Corporation). The antioxidants may be used alone, or in combination with two or more kinds thereof.

### Photosensitizer (I)

A photosensitizer can also be used as an additive.

Specific examples of the photosensitizer include an aromatic nitro compound, coumarins (7-diethylamino-4-methylcoumarin, 7-hydroxy-4-methylcoumarin, ketocoumarin, carbonylbiscoumarin), aromatic 2-hydroxyketone and amino-substituted aromatic 2-hydroxyketones (2-hydroxybenzophenone, mono- or di-p-(dimethylamino)-2-hydroxybenzophenone), acetophenone, anthraquinone, xanthone, thioxanthone, 2-chlorothioxanthone, 2-methylthioxanthone, 2,4-diethylthioxanthone, 2-isopropylthioxanthone, and benzanthrone, thiazolines (2-benzoylmethylene-3-methyl-β-naphthothiazoline, 2-(β-naphthoylmethylene)-3-methylbenzothiazoline, 2-(α-naphthoylmethylene)-3-methylbenzothiazoline, 2-(4-biphenoylmethylene)-3-methylbenzothiazoline, 2-(β-naphthoylmethylene)-3-methyl-β-naphthothiazoline, 2-(4-biphenoylmethylene)-3-methyl-β-naphthothiazoline and 2-(p-fluorobenzoylmethylene)-3-methyl-β-naphthothiazoline), oxazoline (2-benzoylmethylene-3-methyl-β-naphthoxazoline, 2-(β-naphthoylmethylene)-3-methylbenzoxazoline, 2-(α-naphthoylmethylene)-3-methylbenzoxazoline, 2-(4-biphenoylmethylene)-3-methylbenzoxazoline, 2-(β-naphthoylmethylene)-3-methyl-β-naphthoxazoline, 2-(4-biphenoylmethylene)-3-methyl-β-naphthoxazoline, 2-(p-fluorobenzoylmethylene)-3-methyl-β-naphthoxazoline), benzothiazole, nitroaniline (m- or p-nitroaniline, 2,4,6-trinitroaniline) or nitroacenaphthene (5-nitroacenaphthene), (2-[(m-hydroxy-p-methoxy) styryl]benzothiazole, benzoinalkyl ether, N-alkylated phthalone, acetophenoneketal(2,2-dimethoxyphenylethanone), naphthalene, 2-naphthalenemethanol, 2-naphthalenecarboxylic acid, anthracene, 9-anthracenemethanol, 9-anthracenecarboxylic acid, 9,10-diphenylanthracene, 9,10-bis(phenylethynyl)anthracene, 2-methoxyanthracene, 1,5-dimethoxyanthracene, 1,8-dimethoxyanthracene, 9,10-diethoxyanthracene, 6-chloroanthracene, 1,5-dichloroanthracene, 5,12-bis(phenylethynyl)naphthacene, chrysene, pyrene, benzopyran, azoindolizine, furocoumarin, phenothiazine, benzo[c]phenothiazine, 7-H-benzo[c]phenothiazine, triphenylene, 1,3-dicyanobenzene and phenyl-3-cyanobenzoate.

Preferred examples include 9,10-diphenylanthracene, 9,10-diethoxyanthracene and 9,10-dibutoxyanthracene.

Examples of a commercial item thereof include a photosensitizer {9,10-diphenylanthracene (trade name)} made by Kanto Chemical Co., Inc., a photocationic sensitizer {ANTHRACURE (registered trademark) UVS-1101} and {ANTHRACURE (registered trademark) UVS-1331} made by Kawasaki Kasei Chemicals Ltd., and a photoradical sensitizer {ANTHRACURE (registered trademark) UVS-581} made by Kawasaki Kasei Chemicals Ltd.

### Curing Accelerator (J)

A curing accelerator can be used for promoting a reaction between the epoxy resin and the epoxy curing agent and for improving heat resistance, chemical resistance and hardness of the cured film. The curing accelerator is used by being ordinarily added in an amount of 0.01 to 5% by mass based on 100% by mass of the solid content in the resin composition (the remaining component upon removing the solvent from the resin composition). The curing accelerators maybe used alone, or in combination with two or more kinds thereof.

Any of the curing accelerator can be used as long as the curing accelerator has a function of promoting the reaction between the epoxy resin and the epoxy curing agent, and examples thereof include an imidazole-based curing accelerator, a phosphine-based curing accelerator and an ammonium-based curing accelerator. Specific examples thereof include trimethylolpropane triacrylate, ethylene oxide-modified trimethylolpropane tri(meth)acrylate, trimethylolpropane PO-modified triacrylate, trimethylolpropane EO-modified triacrylate, glycerol tri(meth)acrylate, ethoxylated glycerin tri(meth)acrylate, epichlorohydrin-modified glycerol tri(meth)acrylate, diglycerin EO-modified acrylate, alkyl-modified dipentaerythritol penta(meth)acrylate, alkyl-modified dipentaerythritol tetra(meth)acrylate, alkyl-modified dipentaerythritol tri(meth)acrylate, ethoxylated isocyanuric ring tri(meth)acrylate, ε-caprolactone-modified tris-(2-acryloxyethyl)isocyanurate, propylene oxide-modified trimethylolpropane tri(meth)acrylate, epichlorohydrin-modified trimethylolpropane tri(meth)acrylate, ditrimethylolpropane tetra(meth)acrylate, isocyanuric acid EO-modified di/triacrylate, pentaerythritol tri/tetraacrylate (ARONIX M305, M450; Toagosei Co., Ltd.), dipentaerythritol penta/hexaacrylate (ARONIX M402; Toagosei Co., Ltd.), diglycerin EO-modified acrylate, ethoxylated isocyanuric acid triacrylate, tris[(meth)acryloxyethyl]isocyanurate, ethoxylated glycerin triacrylate, ethoxylated pentaerythritol tetraacrylate, 2-undecylimidazole, 2-heptadecylimidazole, 2-phenylimidazole, 2-phenyl-4-methylimidazole and 2,3-dihydro-1H-pyrrolo[1,2-a]benzimidazole.

### Coupling Agent (K)

A coupling agent can also be used for improving adhesion between the cured film formed of the resin composition and the base material, and can be ordinarily used by being added in an amount of 0.01 to 10% by mass based on the total solid content in the resin composition.

As the coupling agent, a silane-based compound, an aluminum-based compound and a titanate-based compound can be used. Specific examples thereof include a silane-based compound such as vinyltrichlorosilan, vinyltrimethoxysilane, vinyltriethoxysilane, 2-(3,4-epoxycyclohexyl)ethyltrimethoxysilane, 3-glycidoxypropyldimethylethoxysilane, 3-glycidoxypropylmethyldiethoxysilane, 3-glycidoxypropyltriethoxysilane, 3-glycidoxypropyltrimethoxysilane, 3-aminopropyltrimethoxysilane, 3-aminopropyltriethoxysilane, 3-methacryloxypropyltrimethoxysilane and 3-methacryloxypropyltriethoxysilane; an aluminum-based compound such as acetoalkoxyaluminum diisopropylate; and a titanate-based compound such as tetraisopropylbis(dioctylphosphite)titanate. Above all, 3-glycidoxypropyltrimethoxysilane is preferred because an effect of improving adhesion is large. Examples of a commercially available coupling agent include Sila-Ace 5510 (JNC Corporation) and Sila-Ace S530 (JNC Corporation).

### Method of Adjusting Varnish

The epoxy resin composition according to one embodiment of the invention may or need not contain the solvent. A varnish can be prepared by dissolving epoxy resin (A) and the compound (B) represented by formula (1) in the solvent (E). When a concentration of the component (B) is high, the varnish is preferably prepared by using the solvent from a viewpoint of the application properties.

Specifically, for example, the varnish can be prepared by mixing a component other than the curing agent, components (A) to (D) and components (G) to (J), and heating the resulting mixture at 70° C. or lower and stirring and dissolving the resulting mixture, and then adding the cationic polymerization initiator as the curing agent (F) thereto, and dissolving the initiator therein.

The vanish can be applied thereonto by applying a general-purpose application method such as spin coating or various printing methods, and the cured material can be produced inexpensively and simply by using the varnish as a coating agent. A coating method and a curing method for the varnish will be described in the following section: 2. Laminate.

### 2. Laminate

A second embodiment of the invention relates to a laminate including a base material, and a cured film formed by curing an epoxy resin composition at least containing epoxy resin (A) and compound (B) represented by formula (1) on the base material.

Epoxy resin (A) and the compound (B) represented by formula (1) both contained in the epoxy resin composition are similar to the epoxy resin and the compound represented by formula (1) both described in the first embodiment. Here, the description on the epoxy resin composition of the first embodiment of the invention described above can be applied to each component or the like forming the epoxy resin composition. Further, from viewpoints of curing shrinkage suppression and high adhesion, a mass ratio of a content of component (A) to a content of component (B) in the epoxy resin composition is further preferably 1.0:0.3 to 1.0:4. 0, and particularly preferably 1.0:0.6 to 1.0:0.95. The description in the section of “Curing step” described later can be applied to a method of curing the epoxy resin composition. Moreover, the epoxy resin composition of the present embodiment contains no phosphor.

### Base Material

The base material is not particularly limited, and only needs to be selected according to an application of the laminate. For example, such a material can be used as a quartz substrate, a glass substrate including barium borosilicate glass and aluminoborosilicate glass, a calcium fluoride substrate, metal oxide including indium tin oxide (ITO), a ceramic substrate, a plastic film including a polycarbonate (PC) film, a silicone-based film, a polyethylene terephthalate (PET) film, a polyethylene naphthalate (PEN) film, a cycloolefin polymer (COP) film, a polypropylene film, a polyethylene film, an acryl polymer film, a polyvinyl alcohol film, a triacetylcellulose film, a polyimide (PI) film and a liquid crystal polymer film, a carbon fiber film, a semiconductor substrate including a silicon wafer, and a metal substrate including a SUS substrate and a copper substrate.

From a viewpoint of adhesion, one kind selected from the group of metal oxide, a plastic film and a metal substrate is preferred.

A method of producing the laminate according to the second embodiment of the invention has a coating step of coating the resin composition on the base material, and a curing step of curing a resin composition layer formed on the base material.

### Coating Step

A method of coating the epoxy resin composition on the base material is not particularly limited, and examples thereof include a method in which a varnish of an epoxy resin composition is added dropwise onto a base material and then the resulting material is applied thereonto by using a wire bar, and a method in which a vanish is applied thereonto by using a gravure coater, a lip coater, a slit die or an inkjet method. In view of capability of evenly applying a predetermined amount of the varnish, a method in which a varnish of an epoxy resin composition is added dropwise onto a base material and then the resulting material is applied thereonto by using a wire bar, or a varnish is applied thereonto by using a gravure coater or a slit die.

An amount of application may be appropriately set according to an intended purpose.

From viewpoints of handling and cost, application of the varnish is preferably performed at an ordinary temperature. Therefore, rotational viscosity of the varnish is preferably 1 to 3,000 mPa·sec, and further preferably 1 to 500 mPa·sec, at 25° C.

### Curing Step

The epoxy resin composition containing epoxy resin (A) and compound (B) represented by formula (1) can be cured by at least one of heating and irradiation with active light, and is preferably cured by ultraviolet light.

When the composition is cured by the active light, a conventionally known method can be used, and as the active light, ultraviolet light can be used. Examples of a light source for irradiating the composition with ultraviolet light include a metal halide type, a high pressure mercury lamp and a UV-LED lamp.

A commercially available apparatus can be used in the curing step. Examples thereof include an ultraviolet exposure apparatus {LH10-10Q (trade name), H bulb (trade name) made by Heraeus K.K.} and an LED ultraviolet exposure apparatus {ASM1503NM-UV-LED (trade name) made by ASUMI GIKEN, Limited}. Then apparatus may be designed so that the coating step and the curing step can be continuously performed.

When the composition is cured by the active light, conditions in the curing step only need to be appropriately set according to a thickness of the epoxy resin composition or the like.

Specifically, for example, the resin composition layer formed by application at a thickness of 4 to 5 micrometers on the base material is irradiated with ultraviolet light having a wavelength of 254 nanometers or 365 nanometers with an integrated exposure of 0.5 to 1.5 J/cm² by using the ultraviolet exposure apparatus {LH10-10Q (trade name), H bulb (trade name)} made by Heraeus K.K.

In addition, irradiation is ordinarily performed from a side of applied surface, but irradiation with ultraviolet light can also be performed from a rear surface side of the applied surface by using a base material through which ultraviolet light can be permeated.

In the case of thermal curing, a heating method is not particularly limited, and for example, a heating means adopting a conventionally known method according to which the composition can be heated at a predetermined temperature, such as a heat circulation system, a hot air heating system, and an induction heating system can be used. As a further preferred method to be used, a curing furnace by hot air circulation or a curing furnace by infrared light can be adopted. Alternatively, heating may be simultaneously performed by simultaneously using a hot air circulation curing furnace and an infrared light curing furnace, or by assembling an infrared heater in the hot air circulation curing furnace. Moreover, a photocuring furnace and a thermal curing furnace may be simultaneously used, or heating and irradiation with the active light may be simultaneously performed.

Curing conditions under which the composition is thermally cured may be appropriately set according to the thickness of the epoxy resin composition or the like.

### 3. Cured Material

The cured material of the epoxy resin composition according to one embodiment of the invention or the laminate according to one embodiment of the invention is suppressed in curing shrinkage during being cured, and has low warpage and high adhesion. Further, the cured material has low warpage and can achieve satisfaction of both high hardness and high adhesion. Moreover, the cured material can have high transparency.

The laminate according to the second embodiment of the invention has high adhesion of 4B or more for all in the adhesion onto three kinds of the base materials in adhesion evaluation by Evaluation method 1 on the epoxy resin composition containing at least epoxy resin (A) and compound (B) represented by formula (1). The adhesion is further preferably 5B or more for all.

Moreover, the cured material preferably has low warpage of less than 1 millimeter in a height of warpage of the base material with the cured film in Evaluation method 2 on the epoxy resin composition containing at least epoxy resin (A) and compound (B) represented by formula (1).

Further, the cured material preferably has high hardness of H or more in pencil hardness in hardness evaluation by Evaluation method 3.

Moreover, when the cured material of the epoxy resin composition according to one embodiment of the invention or the laminate according to one embodiment of the invention is used in an application requiring transparency, total luminous transmittance is preferably 90% or more.

### Evaluation Method 1

Cured films each having a thickness of 4 to 5 micrometers and composed of the epoxy resin composition containing at least the epoxy resin (A) and the compound (B) represented by formula (1) are formed on three kinds of base materials of metal oxide, a metal base material and a plastic film each having a thickness of 50 micromeres.

An adhesion test is performed on a formed cured film by using a crosscut adhesion method with 25 (5×5) lattice patterns at a spacing of 1 millimeter in accordance with ASTM D3359 (Method B) and adhesion is evaluated on the following criteria.

### Evaluation Criteria

5B: 0% in percent area removed;

4B: less than 5% in percent area removed;

3B: 5% or more and less than 15% in percent area removed;

2B: 15% or more and less than 35% in percent area removed;

1B: 35% or more and less than 65% in percent area removed; and

0B: 65% or more in percent area removed;

### Evaluation Method 2

A cured film having a thickness of 4 to 5 micrometers and composed of the epoxy resin composition containing at least the epoxy resin (A) and the compound (B) represented by formula (1) is formed on a 50 micrometer-thick base material to prepare a base material with the cured film.

The base material with the cured film is cut into a lattice of 15 cm×15 cm, and the resulting lattice is allowed to stand with the cured film upward under an atmosphere of 25° C. and 50% RH for 24 hours or more, and then each height of the cured film lifted on four corners on a horizontal table is visually measured. A total value of the heights is deemed as a height of warpage of the base material with the cured film.

A case of curling downward (U shape) is taken as a positive value, and a case of curling upward (inverted U shape) is taken as a negative value.

### Evaluation Method 3

A cured film each having a thickness of 4 to 5 micrometers and composed of the epoxy resin composition containing at least the epoxy resin (A) and the compound (B) represented by formula (1) is formed on a 50 micrometer-thick PET base material.

Pencil hardness is measured on the thus formed cured film by using a pencil scratch tester in accordance with JIS K5600-5-4 (1999). A pencil to be used is sharpened with #1000 sandpaper, and a test is repeated five times for each by using a pencil having identical hardness of a lead by applying a load of 750 g from above to scratch the surface in about 7 millimeters at an angle of 45 degrees on the 50 micrometer-thick PET with the cured film to be measured, and sharpening a tip of the lead of the pencil every time the surface is scratched once, and the pencil hardness is evaluated on the following criteria.

### Evaluation Criteria

Passed in the case on intact surfaces three times or more in the test of five times.

Failed in the case of intact surfaces twice or less in the test of five times.

The pencil hardness with the hardest level at which the film passed the test is taken as “pencil hardness of the cured film.”

With regard to transparency of the cured material, a cured film having a thickness of 4 to 5 micrometers and composed of the epoxy resin composition containing at least the epoxy resin (A) and the compound (B) represented by formula (1) is formed on a 50 micrometer-thick PET base material, and total luminous transmittance of the PET base material with the cured film only needs to be measured by using a haze meter (NDH5000, made by Nippon Denshoku Industries Co., Ltd.).

### Application

The cured material of the epoxy resin composition according to one embodiment of the invention or the laminate according to one embodiment of the invention is preferably used as an adhesive layer of various electronic components from excellent low warpage and adhesion. Moreover, the above materials have high hardness, and therefore are also preferably used as a hard coat layer on an outermost surface of various electronic components. Moreover, the above materials are also preferably used as an insulating material used on a wiring portion of a printed wiring board having an electronic circuit.

### EXAMPLES

Hereinafter, the invention will be described further specifically by describing Examples and Comparative Examples, but the invention is not limited to the Examples as long as the invention is not beyond the gist.

Hereinafter, compounds used in Experimental Examples will be described.

### Component (A): Epoxy Resin

A1: epoxy resin {Celloxide (registered trademark) CEL2021P} made by Daicel Corporation

A2: epoxy resin {Celloxide (registered trademark) CEL8000} made by Daicel Corporation

A3: {ADEKA RESIN (registered trademark) EP-49-10P} made by ADEKA Corporation

(content of phosphorous-containing epoxy resin: 40% by mass)

A4: {ADEKA RESIN (registered trademark) EP-49-10P2 } made by ADEKA Corporation

AB′1: alicyclic epoxy-containing amorphous silsesquioxane according to Synthesis Example 4

(content of phosphorous-containing epoxy resin: 40 to 50% by mass)

### Component (B):Compound Represented by Formula (1)

B1: compound represented by formula (2)

B2: compound represented by formula (3)

B3: compound represented by formula (4)

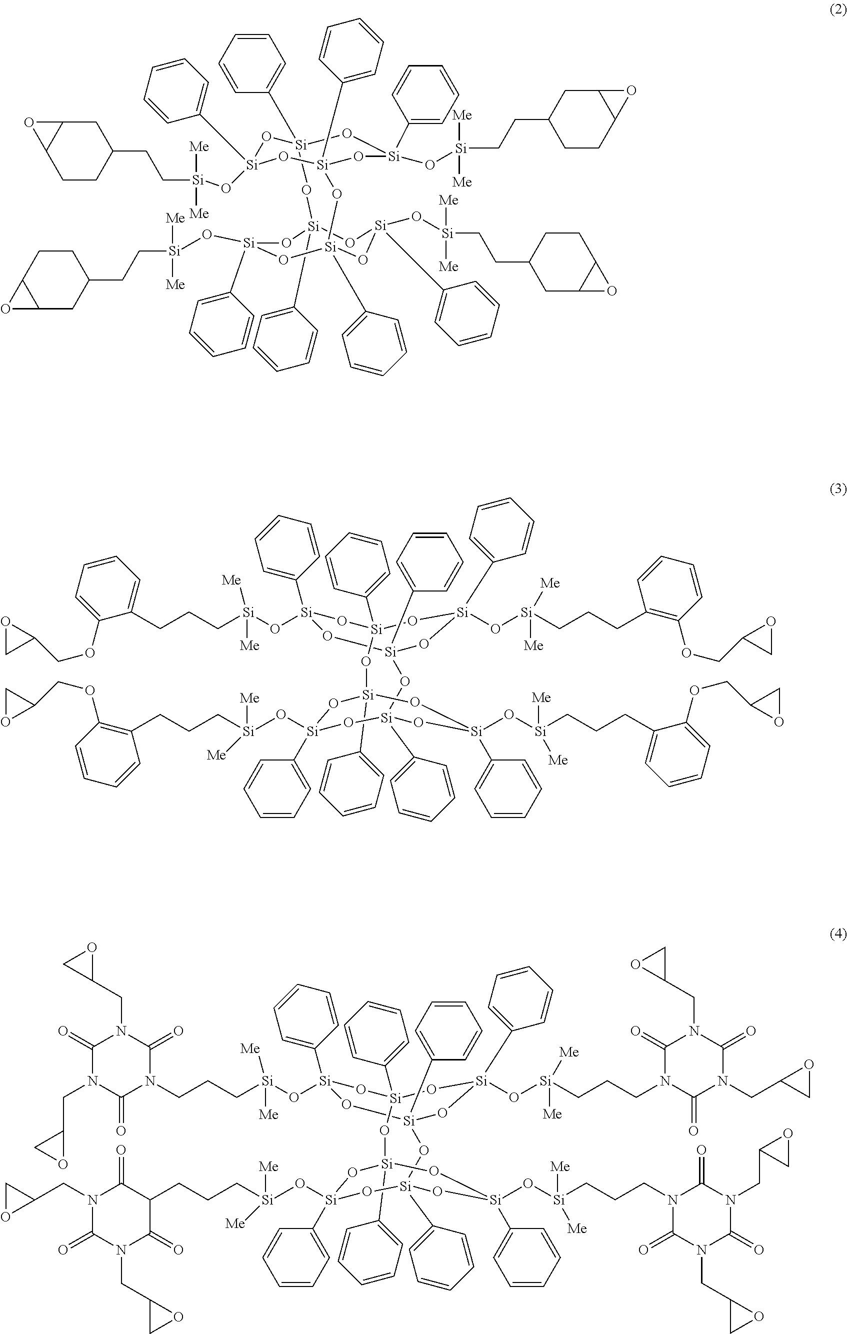

### Component (C): Nanosilica Filler

### Nanosilica-Dispersed Epoxy Resin

C1: nanosilica-dispersed epoxy resin {Nanopox (registered trademark) C620} made by Evonik Industries AG

Organosilica Sol (SiO₂: 40% by mass)

C2: organosilica sol MEK-ST made by Nissan Chemical Corporation

### Component (D): any Other Resin

D1: oxetane resin {Aron Oxetane (registered trademark) OXT-221} made by Toagosei Co., Ltd.

D2: 1,4-cyclohexanedimethanol divinyl ether made by Sigma-Aldrich K.K.

### Component (E): Solvent

E1: methyl isobutyl ketone: {4-methyl-2-pentanone (trade name)} made by FUJIFILM Wako Pure Chemical Corporation

### Component (F): Curing Agent

F1: photocationic polymerization initiator: {CPI-110P (trade name)} made by San-Apro Ltd.

### Component (G): Surfactant

G1: surfactant {MEGAFACE (registered trademark) F563} made by DIC Corporation

G2: reactive silicone {Silaplane (registered trademark) FM-0511} made by JNC Corporation

### Component (H): Antioxidant

H1: antioxidant {ADK STAB (trade name) AO-60} made by ADEKA Corporation

### Component (I): Photosensitizer

I1: photosensitizer {9,10-diphenylanthracene (trade name)} made by Kanto Chemical Co., Inc.

I2: photocationic sensitizer {ANTHRACURE (registered trademark) UVS-1101} made by Kawasaki Kasei Chemicals Ltd.

### Synthesis Example 1

### Synthesis of Tetrafunctional Alicyclic Epoxy-Containing Double-Decker Silsesquioxane (B1)

Compound B1 was produced by the following method.

Into a reaction vessel, 200 g of a compound represented by formula (α) (hereinafter, referred to as compound (α)) prepared by the method disclosed in WO 2004/024741 A and 306 g of anhydrous ethyl acetate (made by Kanto Chemical Co., Inc.) were charged, and the resulting mixture was heated to 75° C. and stirred. Thereto, 0.13 mL of PT-VTSC-3.0X (made by Umicore Japan) was added, and 96 g of Celloxide 2000 (made by Daicel Corporation Chemistry) was added dropwise. Then, the resulting reaction solution was refluxed, and a peak at 2,140 cm⁻¹ was confirmed to be lost by FT-IR, and then heating was stopped, and the resulting solution was cooled to room temperature. Then, 40 g of ethyl acetate (made by FUJIFILM Wako Pure Chemical Corporation) and 15 g of activated carbon (made by FUJIFILM Wako Pure Chemical Corporation) were added thereto, and the resulting mixture was stirred overnight, and the activated carbon was filtered off by using Celite and removed. A filtrate was concentrated with an evaporator until a solid content concentration reached about 80%, and 750 g of methanol (made by FUJIFILM Wako Pure Chemical Corporation) was added thereto while stirring the solution to obtain a white precipitate. The precipitate obtained was subjected to filtration, further washed with methanol, and dried under reduced pressure to obtain 255 g of B1.

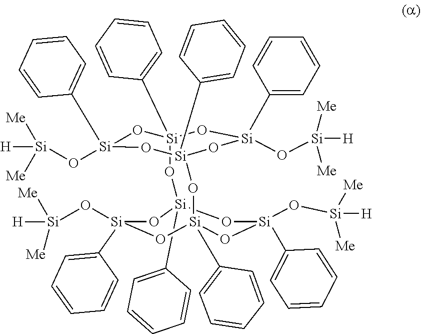 [SMILES: C[SiH](C)O[Si]1(c2ccccc2)O[Si]2(c3ccccc3)O[Si](O[SiH](C)C)(c3ccccc3)O[Si](c3ccccc3)(O1)O[Si]1(c3ccccc3)O[Si](O[SiH](C)C)(c3ccccc3)O[Si](c3ccccc3)(O[Si](O[SiH](C)C)(c3ccccc3)O1)O2]

### Synthesis Example 2

### Synthesis of Tetrafunctional Phenoxy-Containing Double-Decker Silsesquioxane (B2)

Compound B2 was produced by the following method.

Into a reaction vessel, 32 g of compound (α) prepared by the method disclosed in WO 2004/024741 A and 32 g of toluene (made by FUJIFILM Wako Pure Chemical Corporation) were charged, and the resulting mixture was heated to 80° C. and stirred. Thereto, 0.04 mL of PT-VTSC-3.0X (made by Umicore Japan) was added, and 11 g of 2-allylphenylglycidyl ether was added dropwise. Here, 2-allylphenylglycidyl ether can be obtained by the method disclosed in WO 2013/058046 A, J. Am. Am. Chem. Soc., 1983, 105, 586-593, Tetrahedron, 2007, 63, 11341-11348 or the like. Then, the resulting reaction solution was refluxed, and after a peak at 2,140 cm⁻¹ was confirmed to be lost by FT-IR, heating was stopped and the resulting solution was cooled to room temperature. Then, 5 g of activated carbon (made by FUJIFILM Wako Pure Chemical Corporation) was added to the resulting solution, and stirred overnight, and the activated carbon was filtered off by using Hyflo Super-Cel (made by FUJIFILM Wako Pure Chemical Corporation) and removed. A filtrate was concentrated with an evaporator, and resulting solution was re-precipitated with ethyl acetate/hexane=⅛ (in vola), and the resulting precipitate was further washed with hexane 4 times, and dried under reduced pressure to obtain 38 g of B2.

### Synthesis Example 3

### Synthesis of Tetrafunctional Diglycidyl Isocyanurate-Containing Double-Decker Silsesquioxane (B3)

Compound B3 was produced by the following method.

Into a reaction vessel, 32 g of compound (α) prepared by the method disclosed in WO 2004/024741 A and 32 g of toluene (made by FUJIFILM Wako Pure Chemical Corporation) were charged, and the resulting mixture was heated to 80° C. and stirred. Thereto, 0.04 mL of PT-VTSC-3.0X (made by Yumicore Japan) was added, and 33 g of MA-DGIC (1-allyl-3,5-diglycidyl isocyanurate (made by Shikoku Chemicals Corporation)) was added. Then, the resulting reaction solution was refluxed, and after a peak at 2,140 cm⁻¹ was confirmed to be lost by FT-IR, heating was stopped and the resulting solution was cooled to room temperature. The resulting reaction solution was concentrated with an evaporator, and 130 g of acetone (made by FUJIFILM Wako Pure Chemical Corporation) and 8 g of activated carbon (made by FUJIFILM Wako Pure Chemical Corporation) were added to the resulting solution, and the resulting mixture was stirred at room temperature for 3 hours. The activated carbon was filtered off by using Hyflo Super-Cel (made by FUJIFILM Wako Pure Chemical Corporation) and removed. Then, 500 g of methanol (made by FUJIFILM Wako Pure Chemical Corporation) was added to a filtrate, and a viscous lower layer was further washed with methanol, and the resulting material was dried under reduced pressure at 150° C. for 2 hours to obtain 48 g of B3.

### Synthesis Example 4

### Synthesis of Alicyclic Epoxy-Containing Amorphous Silsesquioxane (AB′1)

Resin AB′1 was prepared according to the method described in JP 2005-15581 A.

Into a reaction vessel, 100 parts of 2-(3 4-epoxycyclohexyl) ethyltrimethoxysilane (trade name: Sila-Ace S530, made by JNC Corporation) and 100 parts of methyl isobutyl ketone (made by Tokyo Chemical Industry Co., Ltd.) were charged, and the resulting mixture was heated to 80° C. Thereto, 21.6 parts of 0.1 mass % potassium hydroxide (guaranteed reagent, made by FUJIFILM Wako Pure Chemical Corporation) aqueous solution was added dropwise for 30 minutes. After completion of dropwise addition, the resulting mixture was stirred at 80° C. for 5 hours while formed methanol was removed by a Dean-Stark apparatus. After the reaction, the resulting solution was repeatedly washed with a saturated aqueous sodium chloride solution until an aqueous layer became neutral. A solvent was distilled off under reduced pressure to obtain 70 parts of alicyclic epoxy-containing amorphous silsesquioxane. An epoxy equivalent and a weight average molecular weight of the thus obtained alicyclic epoxy-containing amorphous silsesquioxane were 205 g/eq and 5,500, respectively.

### Preparation of Varnish

As Experimental Examples 1 to 19, a varnish was prepared to be in the composition shown in Table 1 or Table 2.

Components (A) to (E) and components (G) to (I) were put in a brown screw tube, and the resulting material was heated, stirred and dissolved while being held at about 70° C., and then component F (photocationic polymerization initiator) was added thereto as a curing agent and dissolved therein, and the resulting material was taken as a varnish.

In the Tables, components (A) to (E) each are expressed in terms of a value in % by mass when a total of components (A) to (E) is taken as 100% by mass, and a value of components (F) to (H) each is expressed in terms of a value in % by mass when the total of components (A) to (E) is taken as 100% by mass. In addition, a content of component (C) represents a total amount of the nanosilica filler and the epoxy resin, and a content of the nanosilica filler itself is 40% by mass, which is a content of component (C) shown in the Tables.

### Preparation of Cured Film 1: Apparatus 1

A varnish was coated on various base materials each at a thickness of 4 to 5 μm by a wire bar coater. When the vanish contains a solvent, the resulting material was dried in an oven at 80° C. for 1 minute, and then the resulting material was irradiated with ultraviolet light (wavelength: 254 nm, 365 nm) by using an ultraviolet exposure apparatus {LH10-10Q (trade name), H bulb (trade name made by Heraeus K. K.)1 to obtain a cured film. A thickness of the obtained cured film is shown in Tables land 2. In the Tables, UV cure (J/cm²) is expressed in terms of an integrated exposure of ultraviolet light.

### Preparation of Cured Film 2: Apparatus 2

A varnish was coated on various base materials each at a thickness of 4 to 5 μm by a wire bar coater, and the resulting material was irradiated with ultraviolet light (wavelength: 385 nm) by using an LED ultraviolet exposure apparatus {ASM1503NM-UV-LED (trade name) made by ASUMI GIKEN, Limited} to obtain a cured film. A thickness of the obtained cured film is shown in Tables 1 and 2. In the Tables, UV cure (J/cm²) is expressed in terms of an integrated exposure of ultraviolet light.

### Adhesion Test: Adhesion Evaluation

The varnish prepared was applied on an ITO film of a PET base material with the ITO film (made by Sigma-Aldrich K.K.), a 3 mm-thick aluminum base material (made by AS ONE Corporation), a 3 mm-thick copper base material (made by AS ONE Corporation) and a 50 μm-thick PET base material (Lumirror (trademark registration) made by Toray Industries, Inc.) each to prepare a cured film having a thickness of 4 to 5 μm under the similar conditions described above. An adhesion test was performed thereon by using a crosscut adhesion method with 25 lattice patterns at a spacing of 1 millimeter in accordance with ASTM D3359 (Method B), and adhesion was evaluated on the following criteria. The results of evaluation are shown in Tables 1 and 2. In the Tables, ITO represents the PET base material with the ITO film, Al represents the aluminum base material, Cu represents the copper base material, and PET represents the PET base material.

5B: 0% in percent area removed

4B: less than 5% in percent area removed

3B: 5% or more and less than 15% in percent area removed

2B: 15% or more and less than 35% in percent area removed

1B: 35% or more and less than 65% in percent area removed and

0B: 65% or more in percent area removed

### Curling Test: Curing Shrinkage Evaluation

Then, 50 μm-thick PET with a cured film was prepared by the above-described method for preparing the cured film on the 50 μm-thick PET base material.

The 50 μm-thick PET with the cured film was cut into a lattice of 15 cm×15 cm, and the resulting lattice was allowed to stand with the cured film upward under an atmosphere of 25° C. and 50% RH for 24 hours or more, and then each height of the cured film lifted on four corners on a horizontal table was measured, and a total of the heights was taken as a measured value (unit: mm). At that time, curling of the base materials was 0 mm for all the base materials.

In the Tables, a positive value means curling downward (U shape) and a negative value means curling upward (inverted U shape). The results of evaluation are shown in Tables 1 and 2.

### Hardness Evaluation: Pencil Hardness Test

Then, 50 μm-thick PET with a cured film was prepared by the above-described method for preparing the cured film on the 50 μm-thick PET base material.

Pencil hardness of the cured film on the 50 μm-thick PET with the cured film was measured by using a pencil scratch tester in accordance with JIS K5600-5-4 (1999). A pencil to be used was sharpened with #1000 sandpaper, and a test was repeated five times for each by using a pencil having identical hardness of a lead by applying a load of 750 g from above to scratch the surface in about 7 millimeters at an angle of 45 degrees on the 50 μm-thick PET with the cured film to be measured, and sharpening a tip of the lead of the pencil every time the surface is scratched once, and the pencil hardness was evaluated on the following criteria. The results of evaluation are shown in Tables 1 and 2.

### Evaluation Criteria

Passed in the case of intact surfaces three times or more in the test of five times.

Failed in the case of intact surfaces twice or less in the test of five times.

The pencil hardness with the hardest level at which the film passed the test is taken as “pencil hardness of the cured film.”

### Total Luminous Transmittance

Total luminous transmittance was measured on 50 μm-thick PET with a cured film by using a haze meter (NDH 5000, made by Nippon Denshoku Industries Co., Ltd.) (unit: %). The results of evaluation are shown in Tables 1 and 2.

TABLE 1

| | | | Examples | | Comparative Examples | | | | | | | | | | |
|---|---|---|---|---|---|---|---|---|---|---|---|---|---|---|---|
| | | | 1 | 2 | 1 | 2 | 3 | 4 | 5 | 6 | 7 | 8 | 9 | 10 | 11 |
| Resin | Com- | A1 | 7.0 | 6.3 | 42.0 | 40.0 | 40.0 | | | 60.0 | 42.0 | | | | 30.0 |
| compo- | ponent | A2 | | | | | | | | | | 30.0 | 21.6 | | |
| sition | (A) | A3 | | 6.0 | | 30.0 | 30.0 | 60.0 | | | | | | | |
| | Com- | B1 | 20.0 | 18.0 | 12.0 | 20.0 | 20.0 | | 60.0 | | | | | | |
| | ponent | | | | | | | | | | | | | | |
| | (B) | | | | | | | | | | | | | | |
| | Com- | C1 | 30.0 | 27.0 | | | | | | | | | 10.5 | 60.0 | 30.0 |
| | ponent | | | | | | | | | | | | | | |
| | (C) | | | | | | | | | | | | | | |
| | Com- | D1 | 3.0 | 2.7 | 6.0 | 10.0 | 10.0 | | | | | | | | |
| | ponent | D2 | | | | | | | | | 18.0 | 30.0 | 27.9 | | |
| | (D) | | | | | | | | | | | | | | |
| | Com- | E1 | 40.0 | 40.0 | 40.0 | | | 40.0 | 40.0 | 40.0 | 40.0 | 40.0 | 40.0 | 40.0 | 40.0 |
| | pnent | | | | | | | | | | | | | | |
| | (E) | | | | | | | | | | | | | | |
| | Com- | F1 | 1.2 | 1.2 | 1.2 | 1.0 | 2.0 | 1.2 | 1.2 | 1.2 | 1.2 | 1.2 | 1.2 | 1.2 | 1.2 |
| | ponent | | | | | | | | | | | | | | |
| | (F) | | | | | | | | | | | | | | |
| | Com- | G1 | | | | 0.2 | | | | | | | | | |
| | ponent | G2 | 0.18 | 0.18 | 0.18 | | 0.3 | 0.18 | 0.18 | 0.18 | 0.18 | 0.18 | 0.18 | 0.18 | 0.18 |
| | (G) | | | | | | | | | | | | | | |
| | Com- | H1 | 0.6 | 0.6 | 0.6 | 1.0 | 1.0 | 0.6 | 0.6 | 0.6 | 0.6 | 0.6 | 0.6 | 0.6 | 0.6 |
| | ponent | | | | | | | | | | | | | | |
| | (H) | | | | | | | | | | | | | | |
| | Com- | I1 | | | | 0.2 | | | | | | | | | |
| | ponent | I2 | | | | 0.1 | | | | | | | | | |
| | (I) | | | | | | | | | | | | | | |
| UV cure (J/cm²) | | Appa- | 0.5 | 0.5 | 1.5 | | 0.5 | 0.5 | 0.5 | 0.5 | 0.5 | 0.5 | 0.5 | 0.5 | 0.5 |
| | | ratus 1 | | | | | | | | | | | | | |
| | | Appa- | | | | 2 | | | | | | | | | |
| | | ratus 2 | | | | | | | | | | | | | |
| Cured | Film thickness | | 4 | 4 | 4.7 | 5 | 5 | 4 | 4.2 | 4.5 | 5 | 4.2 | 5 | 5 | 5.1 |
| film | (μm) | | | | | | | | | | | | | | |
| | Adhesion | ITO | 5B | 5B | 3B | 5B | 5B | 0B | Film | 0B | 0B | 0B | 0B | 0B | OB |
| | | | | | | | | | break | | | | | | |
| | | Al | 5B | 5B | 5B | 5B | 5B | 0B | Film | 0B | 0B | 2B | 0B | 0B | OB |
| | | | | | | | | | break | | | | | | |
| | | Cu | 5B | 5B | 4B | 5B | 5B | 0B | Film | 0B | 0B | 0B | 0B | OB | OB |
| | | | | | | | | | break | | | | | | |
| | | PET | 5B | 5B | 5B | 0B | 0B | 0B | Film | 0B | 4B | 3B | 2B | OB | OB |
| | | | | | | | | | break | | | | | | |

| | | | | | | | | | | | | | |
|---|---|---|---|---|---|---|---|---|---|---|---|---|---|
| Curling (total of | 0 | 0 | 0 | 0 | 0 | 0 | 0 | −94 | −11 | 45 | 46 | −94 | −127 |
| 4 corners) (mm) | | | | | | | | | | | | | |
| Pencil hardness | 3H | 2H | HB | H | H | H | <6B | H | H | H | 2H | H | H |
| Total luminous | 100 | 100 | 100 | 100 | 100 | 100 | 100 | 100 | 100 | 100 | 100 | 100 | 100 |
| transmission (%) | | | | | | | | | | | | | |

TABLE 2

| | | | Examples | | Comparative Examples | | | | | |
|---|---|---|---|---|---|---|---|---|---|---|
| | | | 3 | 4 | 12 | 13 | 14 | 15 | 16 | 17 |
| Resin | Component (A) | A1 | 7.0 | 7.0 | | 40.0 | | | | |
| compo- | | A2 | | | | 30.0 | | | | |
| sition | | AB′1 | | | | | | | | 60.0 |
| | Component (B) | B1 | | | | | 40.0 | 50.0 | 56.0 | |
| | | B2 | 20.0 | | 60.0 | 20.0 | | | | |
| | | B3 | | 20.0 | | | | | | |
| | Component (C) | C1 | 30.0 | 30.0 | | | | | | |
| | | C2 | | | | | 50.0 | 25.0 | 10.0 | |
| | Component (D) | D1 | 3.0 | 3.0 | | 10.0 | | | | |
| | Component (E) | E1 | 40.0 | 40.0 | 40.0 | | 10.0 | 25.0 | 34.0 | 40.0 |
| | Component (F) | F1 | 1.2 | 1.2 | 1.2 | 1.0 | 1.2 | 1.2 | 1.2 | 1.2 |
| | Component (G) | G1 | | | | 0.2 | | | | |
| | | G2 | 0.18 | 0.18 | 0.18 | | 0.18 | 0.18 | 0.18 | 0.18 |
| | Component (H) | H1 | 0.6 | 0.6 | 0.6 | 1.0 | 0.6 | 0.6 | 0.6 | 0.6 |
| | Component (I) | I1 | | | | 0.2 | | | | |
| | | I2 | | | | 0.1 | | | | |
| UV cure (J/cm²) | | Apparatus 1 | 0.5 | 0.5 | 0.5 | | — | — | — | 0.5 |
| | | Apparatus 2 | | | | 2 | — | — | — | |
| Cured | Film thickness (μm) | | 4 | 4 | 4.8 | 4.7 | — | — | — | 4.5 |
| film | Adhesion | ITO | 5B | 5B | 0B | 5B | — | — | — | 0B |
| | | Al | 5B | 5B | 5B | 5B | — | — | — | 0B |
| | | Cu | 5B | 5B | 5B | 2B | — | — | — | 0B |
| | | PET | 5B | 5B | 5B | 0B | — | — | — | 0B |

| | | | | | | | | |
|---|---|---|---|---|---|---|---|---|
| Curling (total of 4 corners) (mm) | 0 | 0 | 0 | 0 | — | — | — | −47 |
| Pencil hardness | H | H | F | H | — | — | — | 3H |
| Total luminous transmission (%) | 100 | 97 | 100 | 100 | — | — | — | 100 |

The results in Examples 1 to 4 show that the cured film having low warpage, high hardness and high adhesion onto all of the metal oxide film, the metal film and the plastic film can be obtained from the epoxy resin composition containing all of components (A) to (C).

Comparative Examples 1 to 3 and 13 show that adhesion with the base materials is inferior. Moreover, the results in Comparative Examples 6 to 11 show that the film shrank during being cured and warpage is caused in the cured material, when the resin composition contains only component (A) or (B), or only components (A) and (C). Moreover, from comparison between Example 3 and Comparative Example 12, Comparative Example 12 shows that the cured material having low adhesion is formed. The results in Comparative Example 10 show that adhesion is low and large warpage is caused, when the resin composition contains component (C) and does not contain both components (A) and (B). Moreover, Comparative Example 11 shows that adhesion is low and large warpage is caused, when the resin composition contains only components (A) and (C), and does not contain component (B).

Comparative Examples 14 to 16 show that the obtained material is gelled and unable to be evaluated, when the resin composition contains only component (B) and (C), and does not contain component (A).

Comparative Example 17 shows that adhesion is significantly low, even if the resin composition contains silsesquioxane having the epoxy group, when the resin composition does not contain the compound represented by formula (1), and large warpage is caused when PET is used as the base material.

As described above, the invention is described in line with specific embodiments, but each embodiment is represented as an example, and does not limit the scope of the invention. More specifically, each embodiment described in the present specification can be modified in various manners within the range without departing from the spirit, and can be combined with features described in other embodiments within the practicable range.

1. An epoxy resin composition, containing epoxy resin (A), compound (B) represented by formula (1) and nanosilica filler (C): 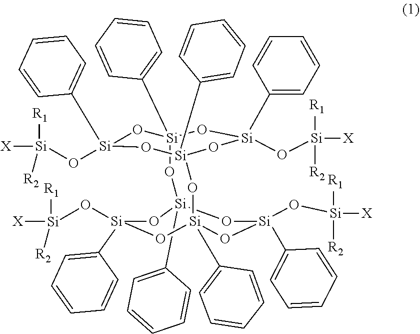
wherein, in formula (1), R₁ and R₂ are independently an alkyl group having 1 to 10 carbons or a phenyl group, and X is independently hydrogen or a monovalent organic group, and in one molecule of the compound, at least one of X includes an epoxy group.

2. The epoxy resin composition according to claim 1, wherein, in the formula (1), all of R₁ and R₂ are a methyl group or an ethyl group.

3. The epoxy resin composition according to claim 1, wherein, in the formula (1), all of X includes an epoxy group.

4. The epoxy resin composition according to claim 1, wherein the epoxy resin (A) contains a phosphorus-containing epoxy resin.

5. The epoxy resin composition according to claim 1, wherein the compound (B) represented by formula (1) contains at least one kind of a compound selected from the group of a compound represented by formula (2), a compound represented by formula (3) and a compound represented by formula (4):

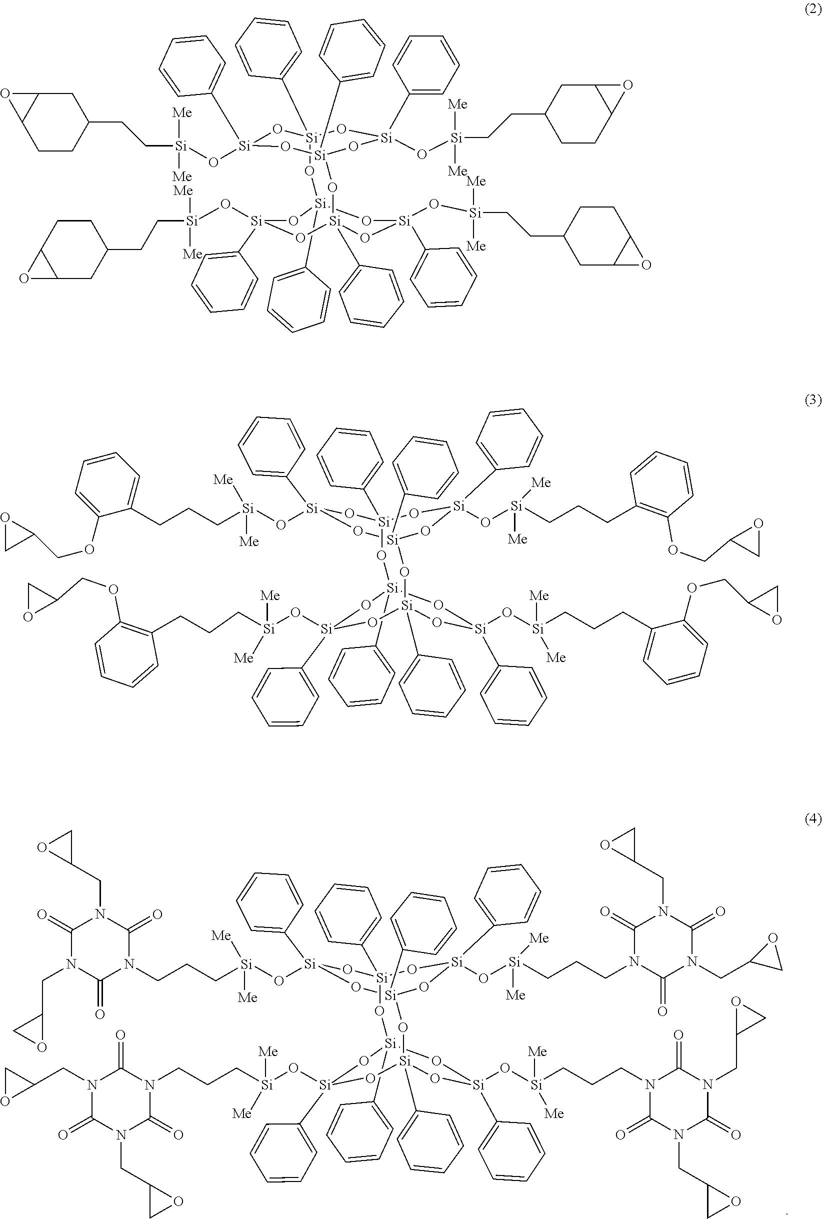

6. The epoxy resin composition according to claim 1, wherein the epoxy resin (A) is a polyfunctional monomer type epoxy resin.

7. The epoxy resin composition according to claim 1, wherein the epoxy resin composition contains 10% by mass or more and 80% by mass or less of epoxy resin (A), 5% by mass or more and 80% by mass or less of compound (B) represented by formula (1) and 5% by mass or more and 35% by mass or less of nanosilica filler (C).

8. The epoxy resin composition according to claim 1, wherein a mass ratio of a content of the epoxy resin (A) to a content of the compound (B) represented by formula (1) is 1:0.2 to 1:5.

9. The epoxy resin composition according to claim 1, further containing resin (D) other than the epoxy resin (A).

10. A laminate, including:
a base material; and
a cured film formed by curing an epoxy resin composition containing at least epoxy resin (A) and compound (B) represented by formula (1) on the base material,
wherein a mass ratio of a content of the epoxy resin (A) to a content of the compound (B) represented by formula (1) in the epoxy resin composition is 1.0:0.3 to 1.0:4.0, and
adhesion on all of three kinds of base materials is rated to be 4B or more on the epoxy resin composition containing at least the epoxy resin (A) and the compound (B) represented by formula (1) in adhesion evaluation by evaluation method 1:
evaluation method 1:
a cured film having a thickness of 4 to 5 micrometers and composed of an epoxy resin composition containing at least the epoxy resin (A) and the compound (B) represented by formula (1) is fonned on three kinds of base materials of metal oxide, a metal substrate and a plastic film each having a thickness of 50 micrometers, respectively; and
an adhesion test is performed on a formed cured film by using a crosscut adhesion method with 25, which is 5×5, lattice patterns at a spacing of 1 millimeter in accordance with ASTM D3359, Method B, and adhesion is evaluated on the following criteria:
evaluation criteria:
5B: 0% in percent area removed;
4B: less than 5% in percent area removed;
3B: 5% or more and less than 15% in percent area removed;
2B: 15% or more and less than 35% in percent area removed;
1B: 35% or more and less than 65% in percent area removed; and
0B: 65% or more in percent area removed; 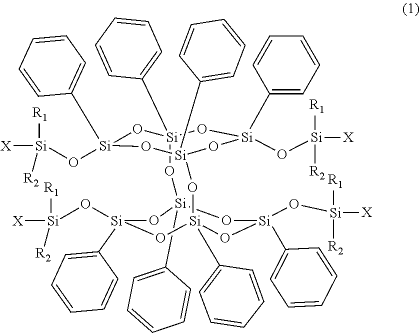
wherein, in formula (1), R₁ and R₂ are independently an alkyl group having 1 to 10 carbons or a phenyl group, and X is independently hydrogen or a monovalent organic group, and in one molecule of the compound, at least one of X includes an epoxy group.

11. The laminate according to claim 10, wherein, in the formula (1), all of R₁ and R₂ are a methyl group or an ethyl group.

12. The laminate according to claim 10, wherein, in the formula (1), all of X include an epoxy group.

13. The laminate according to claim 10, wherein the epoxy resin (A) contains a phosphorus-containing epoxy resin.

14. The laminate according to claim 10, wherein the base material is one kind selected from the group of metal oxide, a plastic film and a metal substrate.

15. An electronic component, including the laminate according to claim 10.
